(19) United States
(12) Patent Application Publication
(10) Pub. No.: US 2018/0048753 A1
(43) Pub. Date: Feb. 15, 2018

(54) OPERATING METHOD FOR UNIVERSAL SERIAL BUS HUB SUPPORTING ROLE-SWITCH FUNCTION

(71) Applicant: ALCORLINK CORP., Taipei City (TW)

(72) Inventors: CHING-HUNG CHAN, TAIPEI CITY (TW); YI-YUAN LIU, TAIPEI CITY (TW); HSIU-MING FAN, TAIPEI CITY (TW)

(21) Appl. No.: 15/294,990

(22) Filed: Oct. 17, 2016

(30) Foreign Application Priority Data
Aug. 12, 2016 (TW) 105125859

(51) Int. Cl. H04M 1/725; H04L 12/40

(52) U.S. Cl. CPC H04M 1/72527; H04L 12/40078

(57) ABSTRACT

The present invention provides an operating method for USB hub supporting role-switch function. The processing unit of the USB hub will transmit a control signal to the first electronic device having both the host mode and the device mode and connecting to the down stream port for changing the operating mode. Thereby, the electronic device is able to access a peripheral device connected to another down stream port. Alternatively, the electronic device can be accessed by the second electronic device having the host mode and connected to the up stream port.

### FIELD OF THE INVENTION

The present invention relates generally to an operating method for hub, and particularly to an operating method for universal serial bus (USB) hub supporting role-switch function capable of controlling the host/device mode of an electronic device connected to the hub.

### BACKGROUND OF THE INVENTION

In the age when personal computers started to develop, each peripheral device of a personal computer has its own connection interface. These peripheral devices perform data transmission with a personal computer via the connection interfaces. For example, keyboards and mice adopt the PS/2 interface to connect with a personal computer; printers, on the other hand, use the LPT interface.

Because different peripheral devices require different connection interfaces, personal computer must be equipped with different connection interfaces for connecting with these peripheral devices. Accordingly, when a user purchases a personal computer or a peripheral device, he naturally must consider if the purchased personal computer or peripheral device includes the corresponding connection interface for connection. This results in inconvenience.

All current peripheral devices adopt USB as the connection interface with personal computers. USB owns the property of high transmission rate. In addition, most current personal computers have built-in drivers for USB. Thereby, once a peripheral device adopts USB as the connection interface, it can be used in most personal computers. Besides, USB has the advantage of plug-and-play. Presently, all electronic apparatuses, including USB flash drives, external CD-ROM players, mobile power packs, and mobile phones, adopt USB as the connection interface.

The data transmission of USB adopts a host/device architecture. Only the electronic device operating the host mode, such as a personal computer, can access the data in the device operating in the device mode. As the performance of portable electronic device is enhanced gradually, some electronic devices might need to perform data transmission with another portable electronic device directly but not through a personal computer. For example, a digital camera has data transmission with a portable hard drive. Unfortunately, the host/device architecture of USB limits the possibility of data transmission between portable electronic devices.

Accordingly, the USB-IF organization announced the USB On-The-Go (OTG) architecture. When the electronic devices including chips supporting the OTG architecture are connecting to each other for data transmission, any one of them can be operated in the host mode while the other is operated in the device mode.

### SUMMARY

An objective of the present invention is to provide an operating method for USB hub supporting role-switch function. By controlling the operating modes of the electronic devices having the host and the device modes and connected to the hub using the processing unit in the USB hub, when a peripheral even without the OTG architecture is connected to an electronic device having both the host and device modes via the hub according to the present invention, data transmission is allowed between the electronic device and the peripheral device.

In order to achieve the above objective and efficacy, according to an embodiment of the present invention, an operating method for USB hub supporting role-switch function is disclosed and applicable when a peripheral device and a first electronic device are connected to the USB hub concurrently. The first electronic device owns a device mode and a first host mode. The USB hub includes a data bus. The steps comprise: when the peripheral device is connected to a first down stream port, the processing unit enabling the peripheral device to access data via the data bus according to the specifications of the peripheral device; when the first electronic device is connected to a second down stream port, the processing transmitting a first control signal to the first electronic device according to the specifications of the first electronic device to make the first electronic device operate in the first host mode; and the first electronic device accessing the peripheral device.

According to an embodiment of the present invention, before the step of the peripheral device connecting to the first down stream port, the method further comprises a step of the processing unit enabling the first down stream port and the second down stream port to operate in the host mode.

According to an embodiment of the present invention, the specification signal of the first electronic device includes that the first electronic device owns both the device mode and the first host mode.

According to an embodiment of the present invention, after the step of the first electronic device accessing the peripheral device and when the second electronic device having a second host mode is connected to an up stream port, the method further comprises steps of the processing transmitting a second control signal to the first electronic device to enable the first electronic device to operate in the device mode; and the second electronic device accessing the peripheral device or/and the first electronic device via the data bus.

According to an embodiment of the present invention, before the step of the processing transmitting the second control signal to the first electronic device to enable the first electronic device to operate in the device mode, the method further comprises a step of the second electronic device transmitting the specifications signal of the second electronic device to the processing unit.

### BRIEF DESCRIPTION OF THE DRAWINGS

FIG. 1 shows a flowchart of the operating method for USB hub supporting role-switch function according to the first embodiment of the present invention;

FIG. 2 shows a schematic diagram of the system for the operating method for USB hub supporting role-switch function according to the first embodiment of the present invention;

FIG. 3 shows a flowchart of the operating method for USB hub supporting role-switch function according to the second embodiment of the present invention; and

FIG. 4 shows a schematic diagram of the operations of the operating method for USB hub supporting role-switch function according to the second embodiment of the present invention.

### DETAILED DESCRIPTION

In order to make the structure and characteristics as well as the effectiveness of the present invention to be further understood and recognized, the detailed description of the present invention is provided as follows along with embodiments and accompanying figures.

According to the prior art, when a peripheral device adopting the OTG architecture, such as mobile flash drives, mice, and keyboards, is connected to an electronic device having both the host and device modes, such as smartphones and personal digital assistants (PDAs), using the OTG protocol, the electronic device can be operated in the host mode. Then the electronic device can have data transmission with the peripheral device operating in the device mode. Nonetheless, it requires all the electronic devices to be connected adopt the OTG architecture. Unfortunately, not all peripheral devices do so. Besides, the manufacturing cost and the hardware design difficulty for the peripheral devices using the architecture will be higher. Accordingly, the present invention provides an operating method controlled by a USB hub for electronic devices having USB and connected to the USB hub. When a peripheral device not adopting the OTG architecture is connected to the hub connected with an electronic device having both the host and device modes, the electronic device can be set to operate in the host mode and thus enabling data transmission between the electronic device and the peripheral device.

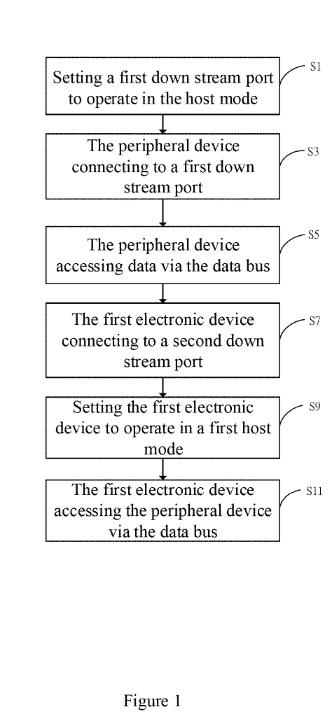

In the following, the process of the operating method for USB hub supporting role-switch function according to the first embodiment of the present invention will be described. Please refer to FIG. 1, which shows a flowchart of the operating method for USB hub supporting role-switch function according to the first embodiment of the present invention. As shown in the figure, the operating method for USB hub supporting role-switch function according to the present embodiment comprises steps of:
Step S1: Setting down stream ports to operate in the host mode;
Step S3: The peripheral device connecting to a first down stream port;
Step S5: The peripheral device accessing data via the data bus;
Step S7: The first electronic device connecting to a second down stream port;
Step S9: Setting the first electronic device to operate in a first host mode; and
Step S11: The first electronic device accessing the peripheral device via the data bus.

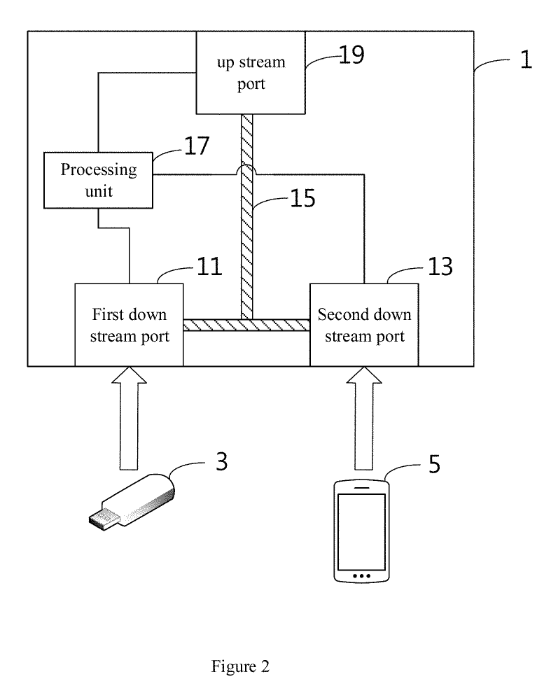

Next, the system required to implement the operating method for USB hub supporting role-switch function according to the present invention will be described. Please refer to FIG. 2, which shows a schematic diagram of the system for the operating method for USB hub supporting role-switch function according to the first embodiment of the present invention. As shown in the figure, the system for the operating method for USB hub supporting role-switch function according to the present invention comprises a USB hub 1, a peripheral device 3, and a first electronic device 5.

The above USB hub 1 includes a first down stream port 11, a second down stream port 13, a data bus 15, a processing unit 17, and an up stream port 19. The first down stream port 11, the second down stream port 13, and the up stream port 19 are all USB ports. The processing unit 17 is an electronic device capable of performing arithmetic and logic operations.

The peripheral device 3 is an electronic device, such as a mobile flash drive, a mouse, or a keyboard, operating in the device mode. The first electronic device 5 is an electronic device including the USB interface and having both the first host mode and the device mode, such as a smartphone or a PDA.

In the following, the process of the operating method for USB hub supporting role-switch function according to the first embodiment of the present invention will be described. Please refer to FIG. 1 and FIG. 2. When the user uses the first electronic device to access the data in the peripheral device, the steps S1 through S11 will be executed.

In the step S1, the down stream ports are set to operate in the host mode. The processing unit 17 transmits a signal to the first down stream port 11 and the second down stream port 13 to make them operate in the host mode.

In the step S3, the peripheral device 3 is connected to the first down stream port 11. To elaborate, the USB interface of the peripheral device 3 is connected to the first down stream port 11.

In the step S5, the peripheral device 3 accesses data via the data bus. When the peripheral device 3 is connected to the first down stream port 11, the processing unit 17 will transmit a first request signal to the peripheral device 3. After the peripheral device 3 receives the first request signal, a first specifications signal of the peripheral device 3 will be transmitted to the processing unit 17. The processing unit 17 judges if the device connected to the first down stream port 11 is the peripheral device 3 operating in the device mode according to the first specifications signal. The processing unit 17 enables the peripheral device 3 to access data via the data bus 15.

In the step S7, the first electronic device 5 is connected to the second down stream port 13. To elaborate, the USB interface of the first electronic device 5 is connected to the second down stream port 13.

In the step S9, the first electronic device 5 is set to operate in the first host mode. When the first electronic device 5 is connected to the second down stream port 13, the processing unit 17 will transmit a second request signal to the first electronic device 5. After the first electronic device 5 receives the second request signal, a second specifications signal of the first electronic device 5 will be transmitted to the processing unit 17. The processing unit 17 judges that the device connected to the second down stream port 13 is the first electronic device 5 having both the first host mode and the device mode according to the second specifications signal, the processing unit 17 transmits a first control signal to the first electronic device 5 to set the first electronic device 5 to operate in the first host mode.

In the step S11, the first electronic device 5 accesses the peripheral device 3 via the data bus 15. The processing unit 17 enables the first electronic device 5 to access data via the data bus 15. At this time, both the peripheral device 3 and the first electronic device 5 access data via the data bus 15. Thereby, the first electronic device 5 operating in the first host mode can access the peripheral device 3 operating in the device mode via the data bus 15.

After the above steps are executed, the operating method for USB hub supporting role-switch function according to the first embodiment of the present invention is completed. By using the operating method for USB hub supporting role-switch function according the present invention, as the down stream ports of the hub are connected concurrently with a peripheral device and an electronic device having both the host and device modes, the electronic device can be set to operate in the host mode by the processing unit of the hub for accessing data in the peripheral device. While using the method according to the present invention, it is not required that the peripheral device connected to the hub should support the OTG architecture. Consequently, the manufacturing cost and the hardware design difficulty for peripheral devices can be reduced.

In what follows, an example of the application of the operating method for USB hub supporting role-switch function according to the first embodiment of the present invention will be described. Please refer to FIGS. 1 and 2. The processing unit (the processing unit 17) of a hub (the USB hub 1) enables the first down stream port (the first down stream port 11) and the second down stream port (the second down stream port 13) of the hub to operate in the host mode (equivalent to the step S1). Then connect a mobile flash drive (the peripheral device 3) to the first down stream port (equivalent to the step S3).

Next, the processing unit transmits a first request signal to the mobile flash drive. When the mobile flash drive receives the first request signal, the first specifications signal of the mobile flash drive is transmitted to the processing unit. According to the first specifications signal, the processing judges that the device connected to the first down stream port is a mobile flash drive, which should be a peripheral device operating in the device mode. Thereby, the processing unit enables the mobile flash drive to access data via the data bus (the data bus 15, and equivalent to the step S5). Afterwards, connect the smartphone (the first electronic device 5) to the second down stream port (equivalent to the step S7).

Then, the processing unit transmits a second request signal to the smartphone. After the smartphone receives the second request signal, the second specifications signal of the smartphone is transmitted to the processing unit. According to the second specifications signal, the processing judges that the device connected to the second down stream port is a smartphone, which should be a device having both the first host mode and the device mode. Thereby, the processing unit transmits a control signal to the smartphone. After the smartphone receives the first control signal, it will operate in the first host mode (equivalent to the step S9). Afterwards, the processing unit enables the smartphone to access the mobile flash drive via the data bus (equivalent to the step S11).

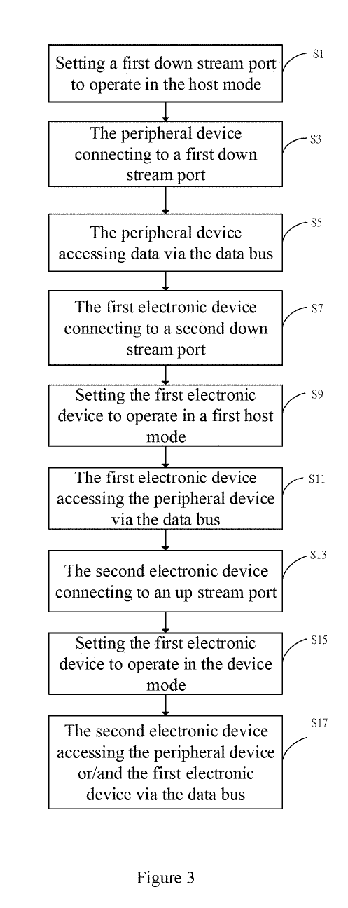

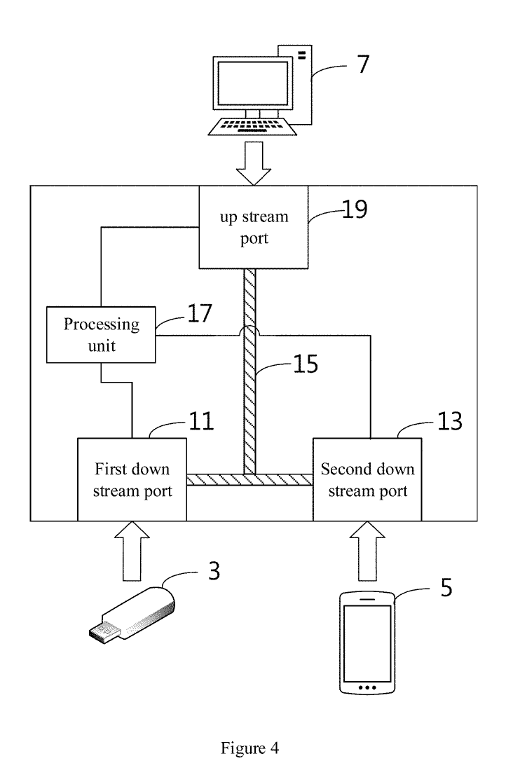

Next, the process of the operating method for USB hub supporting role-switch function according to the second embodiment of the present invention will be described. Please refer to FIG. 3 and FIG. 4, which show a flowchart and a schematic diagram of the operations of the operating method for USB hub supporting role-switch function according to the second embodiment of the present invention. As shown in the figures, the difference between the present embodiment and the first one is that the process according to the present embodiment further comprises steps S13, S15, and S17; the system according to the present embodiment further comprises a second electronic device 7. The rest are identical to those in the first embodiment. Hence, the identical parts will not be described again.

The second electronic device 7 as described above includes a second host mode and can be an electronic device such as a desktop personal computer or a notebook computer.

In the step S13, the second electronic device 7 is connected to an up stream port. To elaborate, the USB interface of the second electronic device 7 is connected to the up stream port 19.

In the step S15, the first electronic device 5 is set to operate in the device mode. The processing unit 17 transmits a second control signal to the first electronic device 5 to set it to operate in the device mode.

In the step S17, the second electronic device 7 operating in the second host mode can access the data in the peripheral device 3 or/and the first electronic device 5 via the data bus.

After the above steps are executed, the operating method for USB hub supporting role-switch function according to the second embodiment of the present invention is completed. By using the operating method for USB hub supporting role-switch function according the present invention, as the down stream ports of the hub are connected concurrently with a peripheral device and an electronic device having both the host and device modes and the up stream port is connected to an electronic device having the host mode, the processing unit of the hub can enable the electronic device connected to the down stream port and having both the host and device modes to operate in the device mode, so that the electronic device connected to the up stream port and having the host mode can access the data in the device connected to the down stream port.

In the following, an example of the application of the operating method for USB hub supporting role-switch function according to the second embodiment of the present invention will be described. Please refer to FIGS. 3 and 4, and to the example of the first embodiment. When a personal computer is connected to the up stream port (the up stream port 19) of the hub (equivalent to the step S13), the processing unit transmits the second control signal to the smartphone. After the smartphone receives the second control signal, it is changed to the device mode (equivalent to the step S15). Then the personal computer can access the data in the mobile flash drive and the smartphone (equivalent to the step S17).

According to an embodiment of the present invention, in the step S15, the processing unit 17 will first transmit a third request signal to the second electronic device 7. After receiving the third request signal, the second electronic device 7 will transmit the third specifications signal of the second electronic device 7 to the processing unit 17. After the processing unit 17 judges that the second electronic device 7 has the second host mode according to the third specifications signal, the processing unit 17 transmits the second control signal to the first electronic device 5 to set the first electronic device 5 to operate in the device mode.

Accordingly, the present invention conforms to the legal requirements owing to its novelty, non-obviousness, and utility. However, the foregoing description is only embodiments of the present invention, not used to limit the scope and range of the present invention. Those equivalent changes or modifications made according to the shape, structure, feature, or spirit described in the claims of the present invention are included in the appended claims of the present invention.

What is claimed is:

1. An operating method for USB hub supporting role-switch function, applicable when a peripheral device and a first electronic device are connected to a USB hub concurrently, said first electronic device having both a device mode and a first host mode, said USB hub including a data bus, and comprising steps of:
a processing unit transmitting a first request signal to said peripheral device and said peripheral device transmitting a first specifications signal to said processing unit when said peripheral device is connected to a first down stream port;
said processing unit enabling said peripheral device to access data via said data bus according to said first specifications signal;
said processing unit transmitting a second request signal to said first electronic device and said first electronic device transmitting a second specifications signal to said processing unit when said first electronic device is connected to a second down stream port;
said processing unit transmitting a first control signal to said first electronic device according to said second specifications signal to set said first electronic device to operate in said first host mode; and
said first electronic device accessing said peripheral device via said data bus.

2. The operating method for USB hub supporting role-switch function of claim 1, and before said step of said processing unit transmitting a first request signal to said peripheral device and said peripheral device transmitting a first specifications signal to said processing unit, further comprising a step of said processing unit setting said first down stream port and said second down stream port to operate in host mode.

3. The operating method for USB hub supporting role-switch function of claim 1, wherein said second specifications signal includes said first electronic device having both said device mode and said first host mode.

4. The operating method for USB hub supporting role-switch function of claim 1, and after said step of said first electronic device accessing said peripheral device via said data bus and when a second electronic device having a second host mode is connected to an up stream port, said method further comprising steps of:
said processing unit transmitting a second control signal to said first electronic device to set said first electronic device to operate in said device mode; and
said second electronic device accessing said peripheral device or/and said first electronic device via said data bus.

5. The operating method for USB hub supporting role-switch function of claim 4, and before said step of said processing unit transmitting said second control signal to said first electronic device to set said first electronic device to operate in said device mode, further comprising a step of said processing unit transmitting a third request signal to said second electronic device and said second electronic device transmitting a third specifications signal to said processing unit.
